(19) United States
(12) Patent Application Publication
(10) Pub. No.: US 2021/0247849 A1
(43) Pub. Date: Aug. 12, 2021

(54) INPUT DEVICE, SIGNAL PROCESSING UNIT THERETO, AND METHOD TO CONTROL THE INPUT DEVICE

(71) Applicant: Clevetura LLC, Minsaya oblast (BY)

(72) Inventors: Valentin V. SOKOL, Minsk (BY); Dzmitry V. ZAKREUSKI, Minsk (BY); Yury V. LAHUTSIK, Minsk (BY); Igor E. SOLOVYOV, Minsk (BY); Mikhail Yu KRUPIANKOU, Minsk (BY)

(73) Assignee: Clevetura LLC, Minsaya oblast (BY)

(21) Appl. No.: 17/251,233

(22) PCT Filed: Jun. 11, 2018
(86) PCT No.: PCT/BY2018/000014

§ 371 Date: Dec. 11, 2020

(51) Int. Cl. G06F 3/02; G06F 3/041; G06F 3/023; G06F 3/0354; G06F 21/31

(52) U.S. Cl. CPC G06F 3/0213; G06F 3/0416; G06F 2203/04104; G06F 3/03547; G06F 21/316; G06F 3/023

(57) ABSTRACT

The invention relates to an input device comprising: a plurality of input keys connected to a first input of a signal processing unit; a touch sensor connected to a second input of the signal processing unit, the touch sensor touch sensor being configured to generate a touch signal corresponding to a movement of one or more objects on or above an upper surface of the one or more of the input keys: and the signal processing unit; wherein there are a plurality of modes of the input device, and wherein the signal processing unit is arranged to: receive the touch signal; determine a signalled mode of the input device based on the touch signal; and enable the signalled mode and/or activate the signalled mode.

The invention relates to electronic and computing equipment, in particular, to human interface devices, namely, the input devices designed to transmit the data subject to conversion into a form suitable for processing by a computer.

Human interface devices (HIDs) are being constantly improved; and in recent years, more and more methods evolve of inputting data into devices of general and professional use. Thus, the devices based on voice recognition, stereo and IR cameras with intelligent pattern recognition are already standard with many users. A special place belongs to devices based on the touch recognition technology, such as touch panels and touch screens. They are used in the broadest range of devices: tablets, phones, watches, etc., since they offer intuitive and simple schemes to control the user interface, and, therefore, are rightfully widely used. At the same time, old types of input devices still exist in parallel, and often are not inferior in popularity. For example, computer mice are still very popular, although begin giving way to touchpads. The same applies to the keyboard, the simplest and one of the first human interface devices (HIDs), based on the binary input, which is still very widespread. Neither virtual touch screen keyboards (like [WO2012143606]), nor the voice input technology (like [U.S. Pat. No. 8,296,383]) could completely replace it, especially when it comes to full-size devices like a desktop personal computer, laptop, tablet, etc. First of all, this is due to the absence of physical keys, which makes it difficult to understand whether a key has been pressed, or whether the finger has moved to another key, due to the absence of the tactile response.

There have been plenty attempts to create an HID that would, through the use of the latest technologies, improve the user's experience of old devices. In particular, we know quite a lot of technical solutions for input devices that combine a typing keyboard with a touch sensor element [U.S. Pat. No. 9,785,251B2, US20130063285A1 and U.S. Pat. No. 9,619,043B2]. All of them are aimed primarily at eliminating the need to transfer the hand from the keyboard to the mouse.

The nearest Prior Art reference to the claimed technical solutions is the input device [US2016154464] comprising a signal processing unit, a plurality of input keys linked to the signal processing unit configured to generate the respective one out of the first set of output control signals, when at least one of the plurality of input keys is activated, and a motion sensor configured to generate the signal respective to an object's motion on or above the upper surface of one or more input keys, when a special key or a toggle switch that prevents the generation of an unwanted signal, is activated.

The main disadvantage of this technical solution, as well as other ones, is that in order to activate the mode in which the touch sensor will catch the transverse finger movements over the surface of a plurality of keys, the user has to press a special controller key. Thus, the solutions, initially aimed at increasing the user's productivity by eliminating the need to switchover among input devices, in fact only makes it a insignificantly faster, yet not eliminating it whatsoever.

Similarly, the above-mentioned technical solutions deals mainly with the control of the mouse pointer cursor, which is a standard function of touch surfaces in existing devices such as a laptop.

The object of the present invention not to roughly combine input devices that would switchover not by a toggle switch, but a “seamless” integration of two technologies with automatic switchover of input modes, by eliminating the need for any additional user's action to pass from one type of input to another, as well as the technology that opens a synergetic potential for completely new input methods, such as camera control in software for 3D simulation, navigation over the canvas in software for 2D design, map navigation in strategy-type games, and the like, including simulation of other input devices used in other specific scenarios.

The object of the invention is embodied in an input device comprising a signal processing unit, a plurality of input keys connected to the signal processing unit configured to generate a respective one out of the first set of output control signals, when at least one of the plurality of input keys is activated, and a motion sensor configured to generate a signal, corresponding to the movement of the object on or above the upper surface of one or more input keys, wherein the signal processing unit is configured to define the number of objects moving simultaneously on or above the upper surface of input keys, the position, the trajectory and the motion speed of each of the above objects, compare each of the above parameters with the respective predefined range or value, and form, depending on whether at least one of the above parameters fits the respective predefined range or value, the second output control signal.

The second output control signal is selected from the group including at least the mouse pointer cursor control signal, the scroll signal, a signal, similar to the above first set of output control signals, and signals simulating the input devices, which include, but not limited to, control panels and special purpose keyboards, in particular, intended for controlling machine tools; musical instruments, in particular, midi keyboards; drum machines; 3D mice; trackballs; touchpads; pointing sticks; touch screens; graphic tablets; joysticks; gamepads; analog sticks; devices for simulating driving and flights such as gearshift levers; steering wheels; steering rudders and pedals; and HID class input devices.

The motion sensor is preferably made by using the capacitive technology and located below the upper surface of input keys, at the level of the keys or above them.

The motion sensor can also represent a camera with the intelligent image recognition technology using the acoustic effects; optical technologies; with the help of a temperature sensor; sensors of pressure; or magnetic field (Hall sensors); tribo sensors; with the use of piezo crystals; and is placed within the boundaries of one or more input keys; and/or around one or several input keys.

The signal processing unit may additionally be configured to generate the third output signal which is consists of raw data from the sensor and may containing an unprocessed data about the position; trajectory; motion; speed and other data from sensors or sensors.

The signal processing unit is configured to define the number of objects simultaneously moving on or above the upper surface of input keys, the position, trajectory and motion speed of each of the above objects, and make a decision on the generation of the second or third output control signal by using the methods of machine learning algorithms.

The object of the invention is embodied in a signal processing unit, with the first input for connecting to a plurality of input keys signal processing unit configured to generate a respective one out of the first set of output control signals, when at least one of the plurality of input keys is activated, and a motion sensor configured to generate a signal, corresponding to the movement of the object on or above the upper surface of one or more input keys, wherein the signal processing unit is configured to define the number of objects moving simultaneously on or above the upper surface of input keys, the position, the trajectory and the motion speed of each of the above objects, compare each of the above parameters with the respective predefined range or value, and form, depending on whether at least one of the above parameters fits the respective predefined range or value, the second output control signal.

The second output control signal is selected from the group including at least the mouse pointer cursor control signal, the scroll signal, a signal, similar to the above first set of output control signals, and signals simulating the input devices, which include, but not limited to, control panels and special purpose keyboards, in particular, intended for controlling machine tools; musical instruments, in particular, midi keyboards; drum machines; 3D mice; trackballs; touchpads; pointing sticks; touch screens; graphic tablets; joysticks; gamepads; analog sticks; devices for simulating driving and flights such as gearshift levers; steering wheels; steering rudders and pedals; and HID class input devices

The signal processing unit may additionally be configured to generate the third output signal which is consists of raw data from the sensor and may containing an unprocessed data about the position; trajectory; motion; speed and other data from sensors or sensors.

The signal processing unit is configured to define the number of objects simultaneously moving on or above the upper surface of input keys, the position, trajectory and motion speed of each of the above objects, and make a decision on the generation of the second or third output control signal by using the methods of machine learning algorithms.

The object of the invention is embodied in the method to control the input device, comprising a signal processing unit, a plurality of input keys connected to the signal processing unit and a motion sensor connected to the signal processing unit, comprising: at activation of at least one of the above plurality of input keys generation by the signal processing unit of the respective one of the set of the first output control signals, and generation, by means of the motion sensor, a signal corresponding to the movement of the object on or above the upper surface of one or more input keys, where the signal processing unit defines the number of objects simultaneously moving on or above the upper surface of input keys, the position, trajectory and the motion speed of each of the above objects, compares each of the above parameters with the respective predefined range or value, and forms, depending on whether at least one of the above parameters fits the respective predefined range or value, the second output control signal.

The second output control signal is selected from the group including at least the mouse pointer, cursor control signal, the scroll signal, a signal, similar to the above first set of output control signals, and signals simulating the input devices, which include, but not limited to, control panels and special purpose keyboards, in particular, intended for controlling machine tools; musical instruments, in particular, midi keyboards; drum machines; 3D mice; trackballs; touchpads; pointing sticks; touch screens; graphic tablets; joysticks; gamepads; analog sticks; devices for simulating driving and flights such as gearshift levers; steering wheels; steering rudders and pedals; and HID class input devices

The signal processing unit may additionally be configured to generate the third output signal which is consists of raw data from the sensor and may containing an unprocessed data about the position; trajectory; motion; speed and other data from sensors or sensors.

The definition of number of objects simultaneously moving on or above the upper surface of input keys, the position, trajectory and motion speed of each of the above objects, and a decision on the formation of the second or third output control signal can be made by using the methods of machine learning algorithms.

The essence of the invention is illustrated but not limited by the following possible embodiments thereof presented in the following figures:

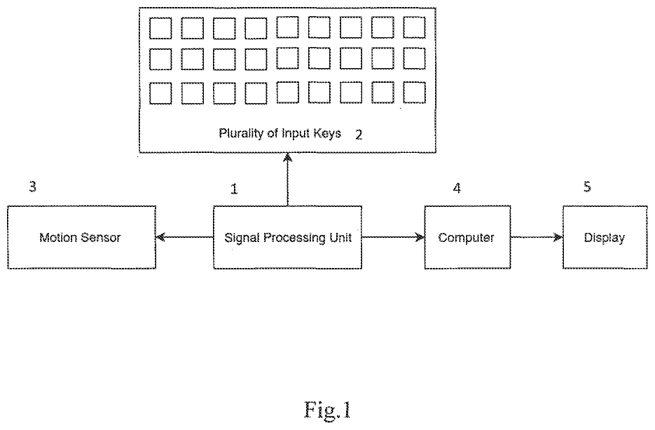

FIG. 1 presents the block diagram of the claimed input device;

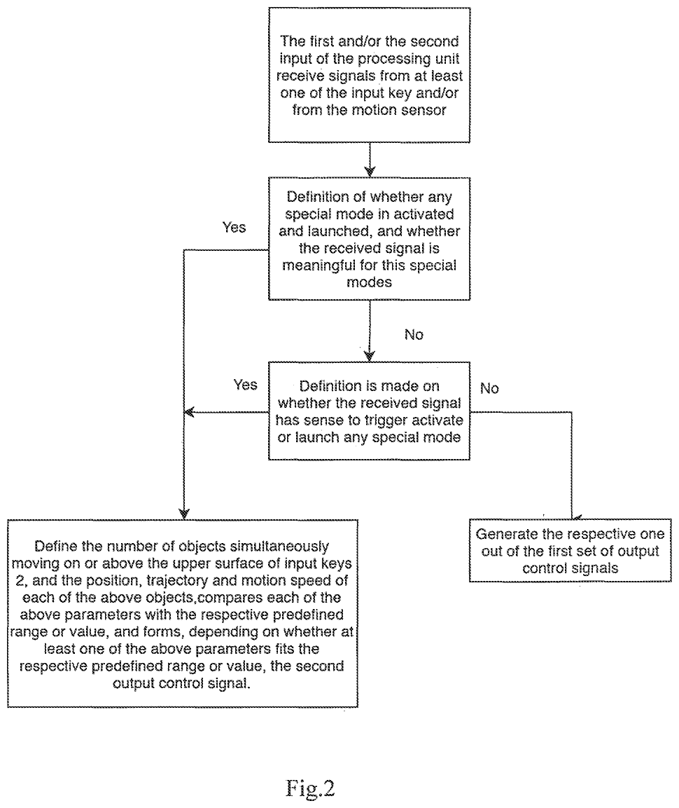

FIG. 2 shows a possible algorithm for implementing the claimed method;

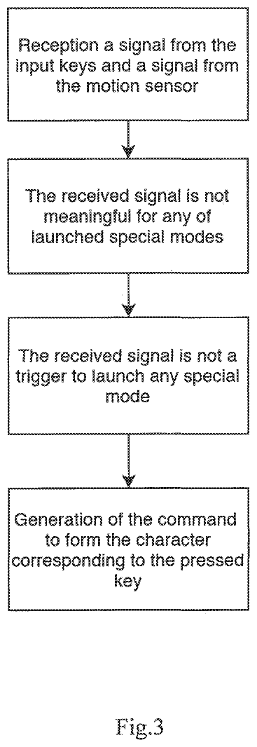

FIG. 3 shows a possible algorithm for implementing the claimed method in the “keyboard” mode;

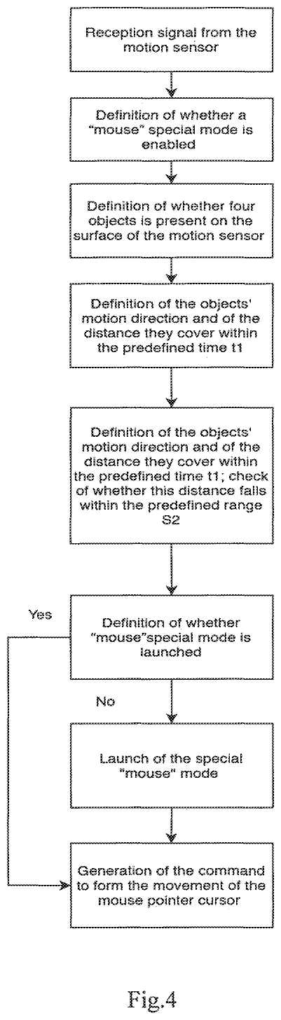

FIG. 4 shows a possible algorithm for implementing the claimed method in the “mouse” special mode;

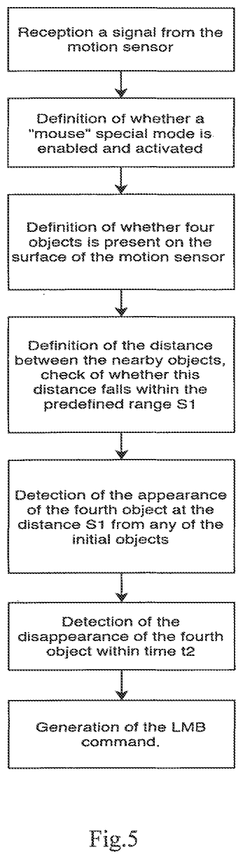

FIG. 5 shows a possible algorithm for implementing the claimed method in the recognition mode of taps (light finger touches with a following finger break-off) as the “left mouse button” (hereinafter—the LMB mode) action as part of the “mouse” special mode;

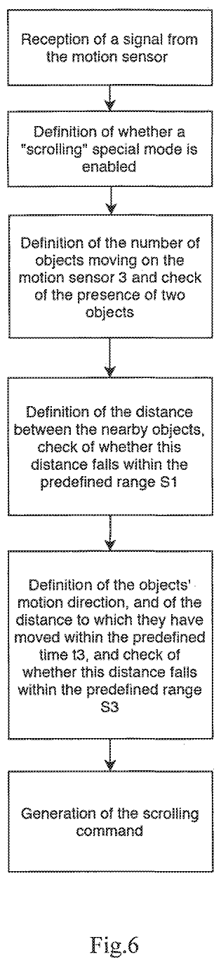

FIG. 6 shows a possible algorithm for implementing the claimed method in a “scrolling” special mode;

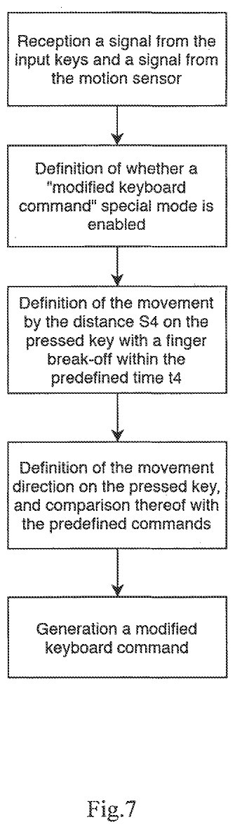

FIG. 7 shows a possible algorithm for implementing the claimed method in the mode of a modified keyboard command by “swipe over the pressed key” special mode example;

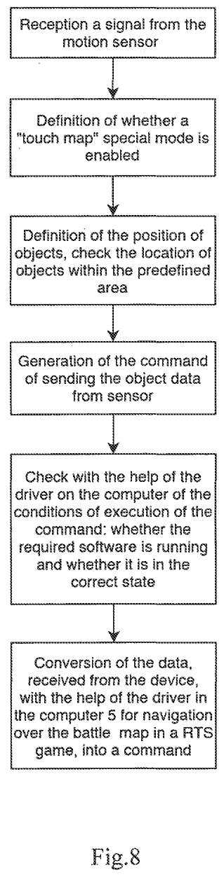

FIG. 8 shows a possible algorithm for implementing the claimed method of touch areas that appear depending on the running software and its context by the “touch battle map navigation” special mode in games of the RTS (real time strategy) type example;

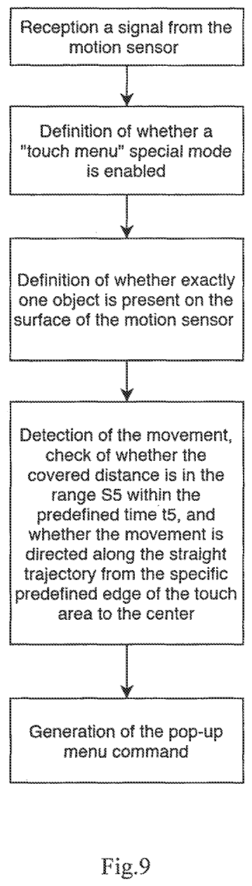

FIG. 9 shows a possible algorithm for implementing the claimed method of touch areas that appear when performing a special predefined action by the “touch menu” special mode;

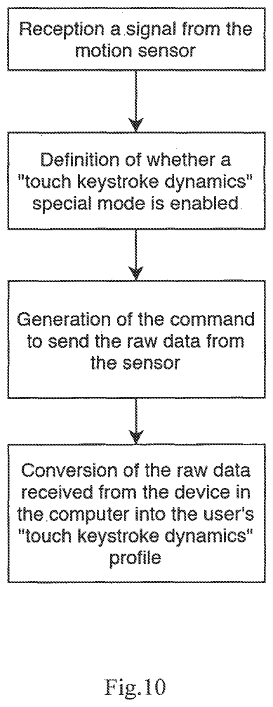

FIG. 10 shows a possible algorithm for implementing the claimed method of touch areas are allocated in advance and work constantly by the data collection mode for further processing to user “touch keystroke dynamics” data.

The input device comprises a signal processing unit 1, a plurality of input keys 2 connected to the first input of the signal processing unit 1, and a motion sensor 3, connected with the second input of the signal processing unit 1, whose output is connected to the computer 4 and the display 5.

The device can stand alone, or be a part of a composite device; for example, it can be built-in into a laptop, an industrial machine tool, an automatic teller machine (ATM), a piece of military equipment; or be a part of a more complex control panel or any other device.

The plurality of input keys 2 is a computer keyboard of any standard design.

Preferably, the motion sensor 3 is made according to the capacitive technology and is located below the upper surface of input keys. Alternatively, such sensors can be located at the level of the keys or above them. Besides, the motion sensor can be made by using the smart image recognition technology, or by using acoustic effects, optical technologies, or with the help of a sensor of temperature, pressure, magnetic field (Hall), a tribo sensor, or by using piezo crystals.

The sensor or sensors can be placed into the device itself, or be located outside, as an individual device, sending data to the signal processing unit 1. The latter can be a composite one, which processes the switchover only, a complex one, which processes all the incoming signals, or a combined one, which processes only a part of signals.

The signal processing unit 1 has the first input for connecting to the plurality of input keys 2, and is configured to generate the respective one out of the first set of output control signals, when at least one of the plurality of input keys 2 is activated. The signal processing unit 1 is also provided with the second input, intended to receive the signal, corresponding to the movement of the object on or above the upper surface of one or more input keys 2, i.e., to receive a signal from the motion sensor 3. Besides, the signal processing unit 1 is configured to define the number of the above objects, the position, trajectory and motion speed of each of the above objects, compare each of the above parameters with the respective predefined range or value, and form, depending on whether at least one of the above parameters fits the respective predefined range or value, the second output control signal.

Some special modes after being enabled required manual activation (for example, by a special gesture), other activates automatically and some are pre-enabled.

The method to control the claimed device, shown in FIG. 2, comprises the following steps:

When at least one of the plurality of input keys 2 is activated, and/or the motion sensor 3 is affected by the appearance/movement of an object on or above the upper surface of one or more input keys 2:

Step 1: the first and/or the second input of the processing unit 1 receive signals from at least one of the input key 2 and/or from the motion sensor 3;

Step 2: a definition is made on whether any special mode in activated and launched on the processing unit 1, and whether the received signal is meaningful for this special modes; if not, go to Step 3, if yes, go to Step 5;

Step 3: a definition is made on whether the received signal has sense to activate or launch any special mode; if not, go to Step 4, if yes, go to Step 5;

Step 4: the signal processing unit 1 generate the respective one out of the first set of output control signals;

Step 5: the signal processing unit 1 defines the number of objects simultaneously moving on or above the upper surface of input keys 2, and the position, trajectory and motion speed of each of the above objects, compares each of the above parameters with the respective predefined range or value, and forms, depending on whether at least one of the above parameters fits the respective predefined range or value, the second output control signal.

The second output control signal can be selected from the group that includes at least the mouse pointer cursor control signal, the scroll signal, a signal similar to the above set of the first output control signals, signals simulating manual input devices, including, but not limited to, special purpose control panels and keyboards, in particular, intended to control machine tools at factories, musical instruments, in particular, midi keyboards, drum machines, 3D mice, trackballs, touchpads, pointing sticks, sensor screens, graphic tablets, joysticks, gamepads, analog sticks, devices for simulating driving or flights, such as gearshift levers, steering wheels, control columns and pedals, and HID-class input devices.

The user simply performs an action on the motion sensor, as if the desired special mode has been already activated, the device itself interprets the user's action and automatically switchovers the special modes. For example, if the user simultaneously shifts his/her four fingers in one direction on the motion sensor, as if he/she has the mouse in hand, the device will automatically turn on the “mouse” special mode for mouse pointer cursor control. In this case, the device can quit any other mode or block it (for example, not to send keyboard commands or interpret them differently), if required.

A specific embodiment of the claimed method is illustrated in several modes, presented by the examples below with reference to respective FIGURES. The mode switchover can be made based on other criteria and algorithms, different from the below examples, such as decisions can be made by using the methods of machine learning algorithms.

The use of the invention includes, but is not limited to, the following scenarios; cases and modes.

### Typing

This is the default “keyboard” mode and it includes typing the text, comprising characters and numbers, and calling other commands by pressing individual keys or combinations thereof. The user makes an input by using the input keys 2, while the signal processing unit 1 simultaneously receives signals from each of the activated keys 2, and the data from the motion sensor 3 about the position and movement of the fingers, which are typical for using the keyboard.

A possible embodiment of the algorithm for processing these signals is shown in FIG. 3 and comprises the following steps:

Step 11: reception a signal from the input key 2 and a signal from the motion sensor 3;

Step 12: definition of whether the received signal is meaningful for any of the launched special modes on the processing unit 1, if not, go to Step 13; otherwise, the signal is either ignored or used in another algorithm;

Step 13: definition of whether the received signal is a trigger to launch any special mode, if not, go to Step 14; otherwise, the signal is either ignored or used in another algorithm;

Step 14: generation of the command to send to computer 4 to form on the display screen 5 the character corresponding to the pressed key 2.

### “Mouse” Special Mode

The mode allows controlling the mouse pointer cursor and simulating the commands of the right\left\middle mouse button. The advantages of controlling the mouse pointer cursor directly from the surface of the keyboard were mentioned in the prototype inventions, and are primarily aimed at eliminating the need for the user to transfer his/her hand at typing from the keyboard to the mouse or touchpad, if there is a need to move the mouse pointer cursor, which can greatly increase the productivity. Thus, according to the authors' approximate evaluation, on average, an office user-operator of a personal computer (PC) with a keyboard and a mouse spends from five to seven working days per year only on transferring his/her hand from the mouse to the keyboard and back. Meanwhile, the user, when using a device, in which he/she can control the mouse pointer cursor and make clicks directly from the surface of the keyboard (keyboard bed), can greatly speed up the work and increase the overall comfort of the inputting process. However, as noted above, in the known Prior Art references, to activate this mode the user needs to press or hold a special key, which also takes away the user's time and attention.

The present invention eliminates the need of both transfer the user's hand to other input devices in order to control the mouse pointer cursor as well as to avoid some additional actions—to activate other input modes such as toggle switch. The user simply performs an action as if the desired mode has been already activated, the device receives the data from the motion sensor and itself interprets the user's action and automatically switchovers the mode.

The switchover conditions can be different. For example, when the user makes a movement, which is not typical for using the keyboard (such as typing characters, numbers, or calling other commands by pressing individual keys or combinations thereof), for example, by simultaneously shifting four fingers (objects) on the keyboard surface, as if he/she has the mouse under his/her hand, the signal processing unit 1 will switchover to the “mouse” special mode, and start sending commands to computer 4 to control the mouse pointer cursor on the display 5. Similarly, if the motion sensor 3 is located around the entire keyboard or at least in the lower part thereof, a switchover can be implemented by tracking in the presence of the user's wrist in the area under the keyboard unit. If both wrists lie on the monitored surface, the device works in the keyboard mode, while if at least one wrist disappears from the monitored surface, the special “mouse” mode is activated. Similarly, the device, while tracking the presence and position of fingers on the keyboard, can itself be in the “keyboard” mode, when there are more than five fingers (i.e., of both hands) on the keyboard bed, and switchover to the “mouse” special mode if only four fingers remain on the keyboard, by interpreting the movements thereof as the motion of the mouse pointer cursor in the PC's monitor.

A possible embodiment of the algorithm for processing these signals is shown in FIG. 4 and comprises the following steps:

Step 21: reception a signal from the motion sensor 3;

Step 22: definition of whether a “mouse” special mode is enabled on processing unit 1, if yes, go to Step 23; otherwise the signal is either ignored or used in another algorithm;

Step 23: definition of the number of objects moving on or above the motion sensor 3, and check of the presence at least of four objects on the surface of the motion sensor 3, if yes, go to Step 24; otherwise, the signal is either ignored or used in another algorithm;

Step 24: definition of the distance between the nearby objects, and check that this distance falls within the predefined range S1, if yes, go to Step 25; otherwise, the signal is either ignored or used in another algorithm;

Step 25: definition of the objects' motion direction and of the distance they cover within the predefined time t1; check of whether this distance falls within the predefined range S2, if yes, go to Step 26; otherwise, the signal is either ignored or used in another algorithm;

Step 26: definition of whether “mouse” special mode is launched on the processing unit 1, if not, go to Step 27, if yes, go to Step 28;

Step 27: launch of the special “mouse” mode in the unit 1, and go to Step 28; and

Step 28: generation of the command to form the movement of the mouse pointer cursor on the display screen 5.

This is a part of the “mouse” special mode, the signal processing unit 1 will recognize the taps (light touches with a finger break off) on the surface of any key 2, as if the left mouse button (hereafter—the LMB) has been pressed. The unit 1 can be configured to process a pressing of the input key 2, which occurred at that moment under the finger in “mouse” special mode, as LMB command, and to block original input key 2 command.

A possible embodiment of the algorithm for processing these signals is shown in FIG. 5 and comprises the following steps:

Step 31: reception a signal from the motion sensor 3;

Step 32: definition of whether a “mouse” special mode is enabled and activated on processing unit 1, if not, go to Step 33; otherwise, the signal is either ignored or used in another algorithm;

Step 33: definition of the number of objects moving on the motion sensor 3, check the presence of three objects on the surface of the motion sensor 3, if yes, go to Step 34; otherwise, the signal is either ignored or used in another algorithm;

Step 34: definition of the distance between the nearby objects, check of whether this distance falls within the predefined range S1, if yes, go to Step 35; otherwise, the signal is either ignored or used in another algorithm;

Step 35: detection of the appearance of the fourth object at the distance SI from any of the initial three objects, if it appears, go to Step 36; otherwise, the signal is either ignored or used in another algorithm;

Step 36: detection of the disappearance of the fourth object within time t2 (with or without pressing the input key), if it disappear, go to Step 37; otherwise, the signal is either ignored or used in another algorithm;

Step 37: generation of the LMB command.

### “Scrolling” Special Mode

This is the mode of scrolling the content of pages, documents, etc. If the number of fingers is changed; for example, if there are two fingers present and moving on the sensor 3, the signal processing unit 1 will start interpreting the data received from the motion sensor 3 by sending scrolling commands to the display 5 (will switchover to the “scrolling” special mode).

A possible embodiment of the algorithm for processing these signals is shown in FIG. 6 and comprises the following steps:

Step 41: reception of a signal from the motion sensor 3;

Step 42: definition of whether a “scrolling” special mode is enabled on processing unit 1, if yes, go to Step 43; otherwise, the signal is either ignored or used in another algorithm;

Step 43: definition of the number of objects moving on the motion sensor 3 and check of the presence of two objects on the surface of the motion sensor 3, if yes, go to Step 44; otherwise, the signal is either ignored or used in another algorithm;

Step 44: definition of the distance between the nearby objects, check of whether this distance falls within the predefined range S1, if yes, go to Step 45; otherwise, the signal is either ignored or used in another algorithm;

Step 45: definition of the objects' motion direction, and of the distance to which they have moved within the predefined time t3, and check of whether this distance falls within the predefined range S3, if yes, go to Step 46; otherwise, the signal is either ignored or used in another algorithm;

Step 46: generation of the scrolling command.

### Using Gestures

The device assumes a possibility of using all the standard gestures that are available in modem touchpads right on keyboard bed, namely: pinch in, pinch out, panning and others. Also, the device makes it possible to perform other gestures. For example, five fingers of one hand can rotate 3D objects in 3D spaces, which is especially convenient in video games and when working with software for building or viewing 3D models, thus replacing the 3D mice and eliminating the need to transfer the hand from the keyboard thereto.

See below some of the gestures embodied in the device.

### Swipe Over Pressed Key

The function of pressing a key with a finger movement aside allows extending the physical key's functionality by several times. If in a usual keyboards, only one signal can be extracted from a key, by using the technology of tracking the finger motion over the keys surface, the number of possible signals increases significantly.

In this mode, the processing unit 1 can distinguish usual presses of the physical key 2 and the presses of the key 2 with a finger swipe to one of the four sides (up, down, right, or left).

For example, the processing unit 1 can send the command to print a character “p” after simple press of the “p” key, and by pressing with a swipe upwards send the command to print a capital character “P”, thus, eliminating the need to hold the “Shift” key. In the same way, when pressing with a swipe downwards, the command will be sent that simulates pressing “ctrl” together with the “p” key, invoking the printing dialog box.

This function can be used to simplify the input of text-symbol information. For example, for typing in languages with Latin alphabet, but which have characters with diacritic marks or ligatures, which often requires from the user to press modifier keys to type them, which greatly slows the input speed. The same applies to typing in other languages, which consist of a large number of characters, for example, in languages with hieroglyphic writing.

Thus, the function can be used to assign several other specific commands or macros to one key, which is especially useful in a professional software, which has a large number of commands, the access to which is difficult due to complicated menu structure in the graphical interface, or whose initiation is by an ergonomically inconvenient combination of keys, for example, by pressing the combination of “ctrl+o” (i.e., the keys are too far from each other to press them with fingers of one hand). Other examples include the need to call media functions by pressing the “fn” key at the same time with pressing one of the functional keys (fn+f1\f2\ . . . \f12), in which the user needs to either use both hands, or by uncomfortably stretching the finger of one hand from one key to another. For competitive gamers, the assigning macros to keys on which they already have their fingers to control the game process will also save a lot of time, by eliminating the need to feel for specific hard-to-reach key as well as to reach for it, thus giving a serious advantage over the rivals.

In other cases, more sensitive reading of the finger's swipe direction may be used, so in some computer games a spell will be casted in the direction—from the user's character, in which the user has made a swipe on the pressed key which is responsible for usual spell cast; regulation of a grenade throw force depending on how quickly the swipe is made; or an adjustment of the character's movement speed by moving the finger up and down on the pressed key. These functions can be implemented either by processing a raw data directly on the computer, or by simulating other input devices such as joystick with analog sticks, allowing, for instance, to change the movement speed depending on the force applied.

A possible embodiment of the algorithm for processing these signals is shown in FIG. 7 and comprises the following steps:

Step 51: reception a signal from the input key 2 and a signal from the motion sensor 3;

Step 52: definition of whether a “modified keyboard command” special mode is enabled on processing unit 1, if yes, go to Step 53; otherwise, the signal is either ignored or used in another algorithm;

Step 53: definition of the movement by the distance S4 on the pressed key 2 with a finger break-off within the predefined time t4, if yes, go to Step 54; otherwise, the signal is either ignored or used in another algorithm;

Step 54: definition of the movement direction on the pressed key 2, and comparison thereof with the predefined commands, if yes, go to Step 55; otherwise, the signal is either ignored or used in another algorithm;

Step 55: generation by the unit 1 of a modified keyboard command to send to computer 4

### Using Part of Keyboard Bed as a Permanently Working Touchpanel

The device can be programmed to select individual areas of the keyboard bed for assigning to them of some special, context-depending functionality. The area can be one or more with the assigned different functions. The remaining part of the keyboard bed can function as a regular keyboard, or, vice versa, in the standby mode, ready to turn on any other special mode.

The signals sent to the computer from the special device areas can simulate other input devices in order to simplify the processing thereof and software development; they may be sent in the form of specific commands intended for subsequent processing by a special driver or special software installed to the computer, or in the form of a raw data, where they will be further collected or processed by means of a driver or special software.

By the type of assignment, three main area types can be identified: touch areas appear depending on the running software and its context; touch areas appear when performing a special predefined action; and touch areas are allocated in advance and work constantly.

Touch areas appear depending on the running software and its context thereof.

This special mode has the widest range of applications, but its specificity lies in the fact that specific touch areas are defined and linked to specific software; and they may appear not always, but only if some particular conditions are met. The mode can be programmed and linked to the existing software in the special program for the device settings; however, a higher efficiency and flexibility can be achieved if the software developers themselves will make native supports of the device.

This mode will be useful in computer games. For example, an area can be assigned under a player's finger, next to the area containing the keys needed to control the fight in the game of the RTS genre; and, while moving the finger in this area, the player will move the camera over the battlefield, thus, eliminating the need to use the mouse or arrow keys, which will allow to simultaneously control the army and the navigation over the battlefield, which in turn will provide the player with a competitive advantage over other players.

In other genres of computer games, a similar principle can be implemented, for example, listing the objects of a character's inventory with a little finger or another finger, little involved in controlling the game.

In the same way, such functionality can be used in the professional graphic software; CAD software; in the video or audio processing software; and in other software, where there is some kind of canvas or a virtual working surface, the navigation over which is an integral part of the workflow.

This method opens up additional possibilities for using the bimanual input. For example, in the graphics software, when the user launches the color palette dialog box, the device can highlight (with a backlight) and isolate a specific area on the keyboard bed, in which a finger movement will correspond to the movement of the color selective-cursor. Computer graphic (CG) artists that works with a digital graphic pen in one hand can use the other hand for selecting the color on right on the keyboard bed, as if holding a real palette with a brush, eliminating the need to move hand, and, thus, lose the current position of the cursor-brush in the virtual canvas. Another example, is usage of an a some row of keys, for instance, the numerate row of keys (“1”, “2”, “3”, . . . “O”) can be programmed to work as a virtual slider that will change the size of the brush or color transparency as CG artist moves his finger over this area. This is especially convenient since the keyboard bed has a tactile response from the keys, which makes it easier to understand how far a finger has traveled. In the software intended for editing video or audio materials, individual keys can serve as small virtual sliders, each of them is in charge of a separate variable value, such as contrast, saturation, exposure, etc., and thus, by making small movements with individual fingers, the user can immediately change several variables.

In this mode, certain areas of the device can be set up to simulate other input devices, thus, for example, one half of the sensor part of the device can simulate the human interface device (HID) of the racing wheel, while the second half thereof can simulate the HID of the pedals, thus, in computer game, it is possible to control a car solely by the sensor, which will give an additional advantage due to increased control sensitivity.

This mode can also be used to control system events of the operating system. For example, when pop-up windows or dialog menu appear, swipes to the sides over a specific area of the device will result in a specific action in the given dialog window (confirmation, saving, canceling, etc.). This also eliminates the need to move the mouse pointer cursor to the desired key, or select the desired key with arrow keys.

Another example of the system embodiment can be the text inputting. A certain area of the keyboard bed can be assigned to navigate over the prompt line of the predictive input, which suggests options of ends of words and phrases, and can also suggest corrections of common errors. Currently, to do this the user needs to reach for the arrow keys, or select the desired hint with the mouse pointer cursor. When assigning a touch navigation area by the prompt line of the predictive input directly on keyboard bed, the user has no need to reach anywhere.

A particular case of this application, is the typing using a phonetical type of input such as Chinese Pinyin method, where in order to type the required hieroglyph, one has to firstly to write its phonetic transcription, and then select the accordant hieroglyph from the pop-up list.

A possible embodiment of the algorithm for implementing the claimed method of touch areas that appear depending on the running software and its context by the “touch battle map navigation” special mode in games of the RTS (real time strategy) type example is shown in FIG. 8 and comprises the following steps:

Step 61: reception a signal from the motion sensor 3;

Step 62: definition of whether a “touch map” special mode is enabled on processing unit 1, if yes, go to Step 63; otherwise, the signal is either ignored or used in another algorithm;

Step 63: definition of the position of objects, check the location of objects within the predefined area on the motion sensor 3, if yes, go to Step 64; otherwise, the signal is either ignored or used in another algorithm;

Step 64: generation of the command of sending the object data (the position, number, trajectory, speed, etc.) to the computer 4;

Step 65: check with the help of the driver on the computer 5 of the conditions of execution of the command: whether the required software is running and whether it is in the correct state, if yes, go to Step 66; otherwise, the signal is either ignored or used in another algorithm;

Step 66: conversion of the data, received from the device, with the help of the driver in the computer 5 for navigation over the battle map in RTS game, into a command.

Touch areas appear when performing a special, predefined action on the device itself.

The touch area is activated when making some gesture. This function can be used to call a touch menu with an additional functionality. The user can make a swipe from the edge of the keyboard bed, while the menu will appear on the display from the same side. The menu can be contextually changed and adjusted. For example, it can be used to call a table with emoji symbols, while typing a text, which will greatly increase the user's inputting speed. The navigation over the menu can take place both in traditional ways, and when using the device's touch capabilities, such as when calling a touch menu, a certain zone of the keyboard bed will be activated and highlighted; while the finger movement thereon will correspond to the motion of a special touch cursor lopped within this touch menu. Such touch menu can be used in computer games, professional and other software in order to speed up the access to certain functions; to run certain commands or a sequence thereof; or to duplicate certain hard-to-reach keys or combination thereof.

A possible embodiment of the algorithm for implementing the claimed method of touch areas that appear when performing a special predefined action by the “touch menu” special mode is shown in FIG. 9 and comprises the following steps:

Step 71: reception a signal from the motion sensor 3;

Step 72: definition of whether a “touch menu” special mode is enabled on processing unit 1, if yes, go to Step 73; otherwise, the signal is either ignored or used in another algorithm;

Step 73: definition of the number of objects moving on the motion sensor 3, check of the presence of strictly one object on the surface of the motion sensor 3, if yes, go to Step 74; otherwise, the signal is either ignored or used in another algorithm;

Step 74: detection of the movement, check of whether the covered distance is in the range SS on the motion sensor 3 within the predefined time t5, and whether the movement is directed along the straight trajectory from the specific predefined edge of the touch area to the center, if yes, go to Step 75; otherwise, the signal is either ignored or used in another algorithm;

Step 75: generation of the pop-up menu command.

Touch areas are allocated in advance and work constantly.

This is the operation mode, when data from the device are constantly coming into the computer, but at the same time, the device works as usual, allowing tracking the position of user's hands. It can be used in various ways.

For example, it can be used to collect additional data for the subsequent use in forming user's “keystroke dynamics” (a detailed data of how exactly a user types that used to forms a user biometrics profile for authentication, such as in [U.S. Pat. No. 8,332,932]) with not only typing, but with hands' position over the keyboard.

The method can give additional information about the user's habits, the way he/she transfers fingers, for how long he/she keeps them on the keys, and in which key areas he/she holds the fingers. All this can give a more detailed “portrait”, which can be used for authentication, tracking any unauthorized access to other people's information, or in other areas.

This operation mode is also suitable for the continuous input method by analogy with the continuous stroke word-based text input typing method (known from [U.S. Pat. No. 7,098,896B2]), but directly on the keyboard bed.

Also, displaying on the monitor screen the current position of user's fingers on the keyboard bed could help forming in the user of a habit not to look at the physical keyboard itself during inputting, which is one of the key habits for the touch typing (“blind” typing), helping to form the tactile, not visual, memory of key positions.

Likewise, the user can trained to memorize key combinations as shortcuts, hotkeys. For example, when pressing and holding the modifier key, the monitor will show the keyboard image with the current location of fingers on the keyboard bed, and the respective commands, which will be initiated when clicking on a specific key.

This method can also be used to control the device itself, for example, to turn on or off the keyboard backlight, depending on the presence or absence of user's hands thereon.

A possible embodiment of the algorithm implementing the claimed method of touch areas are allocated in advance and work constantly by the data collection mode for further processing to user “touch keystroke dynamics” data is shown in FIG. 10 and consists of the following steps:

Step 81: reception a signal from the motion sensor 3;

Step 82: definition of whether a “touch keystroke dynamics” special mode is enabled on processing unit 1, if yes, go to Step 83; otherwise, the signal is either ignored or used in another algorithm;

Step 83: generation of the command to send the raw data from the sensor 3;

Step 84: conversion of the raw data received from the device in the computer 5 into the user's “touch keystroke dynamics” profile.

Thus, the aim of the invention to eliminate the need for whatever additional user's action to switchover from one input mode to another has been successfully achieved.

The user simply performs some action on or above the surface of the motion sensor, as if the desired mode has already been activated; the device itself interprets the user's action and automatically switchovers the modes (for example, if the user is simultaneously moving four fingers in one direction on or above the said surface, as if he/she had a mouse at hand, the device will automatically turn on the mouse pointer cursor control mode).

It should be noted that any mentioning of an “a”, “an” or “the” is intended to mean “one or more”, unless specifically indicated otherwise.

1-14. (canceled)

15. An input device comprising:
a signal processing unit;
a plurality of input keys connected to a first input of the signal processing unit; and
a touch sensor connected to a second input of the signal processing unit, the touch sensor being configured to generate a touch signal corresponding to a movement of one or more objects on or above an upper surface of the one or more of the input keys;
wherein there are a plurality of modes of the input device, and wherein the signal processing unit is arranged to:
receive the touch signal;
determine an active mode of the input device;
determine whether the touch signal is meaningful for the active mode;
determine a signalled mode of the input device based on the touch signal; and
enable the signalled mode and/or activate the signalled mode in dependence on the touch signal being meaningful for the signalled mode and not being meaningful for the active mode.

16. The device of claim 15, wherein the touch signal being meaningful for a mode comprises the signal processor being arranged to generate an output signal based on the touch signal when the input device is in said mode, the output signal being defined for a combination of said touch signal and said mode.

17. The device of claim 15, wherein the signal processor is arranged to determine one or more enabled modes of the input device.

18. The device of claim 17, wherein determining the signalled mode comprises determining an enabled mode for which the touch signal is meaningful.

19. The device of claim 18, wherein the signal processor is arranged to activate the determined enabled mode.

20. The device of claim 15, wherein determining the signalled mode comprises determining a mode for which the touch signal is a trigger to launch, enable, and/or activate, said mode.

21. The device of claim 15, wherein the signal processing unit is arranged to determine a parameter relating to the movement of one or more objects on or above the upper surface of the input keys, preferably wherein the signal processing unit is arranged to determine one or more of:
a number of objects;
the position of the objects;
the trajectory of the objects;
the speed of the objects; and
a distance between two or more of the objects.

22. The device of claim 21 wherein the signal processing unit is arranged to determine the signalled mode in dependence on the parameter being within a predetermined range and/or being equal to a predetermined value.

23. The device of claim 15, wherein the signal processing unit is arranged to receive a keypress signal at the first input; and/or wherein the determination of the signalled mode is dependent on a/the keypress signal.

24. The device of claim 15, wherein the signal processor is arranged to provide an output signal in dependence on one or more of:
the touch signal; and
a keypress signal received at the first input;
wherein:
the output signal is dependent on the signalled mode and/or an active mode; and/or
the output signal relates to one or more of: a pointer signal; a scroll signal; and a keypress signal.

25. The device of claim 15, wherein the determination of the signalled mode is dependent on one or more of:
a machine learning algorithm;
a number of wrists lying on the input device;
a number of fingers on the input keys;
a change in a number of fingers on the input keys; and
a utilised area of the touch sensor.

26. The device of claim 15, wherein the touch sensor is located below the upper surface of the input keys.

27. The device of claim 15, wherein the touch sensor is located one or more of:
above the level of the input keys;
at the level of the input keys;
within the boundaries of one or more of the input keys; and
around one or more of the input keys.

28. The device of claim 15, wherein the touch sensor is arranged to be activated based on a gesture.

29. The device of claim 15, wherein the signal processor is arranged to record information relating to a user's habits; wherein the user's habits are used to authenticate the user and/or to track unauthorized access to information.

30. The device of claim 15, wherein the signal processor is arranged to transmit a signal to a monitor so as to cause a position of a user's fingers on the input device to be shown on the monitor.

31. The device of claim 15, wherein the plurality of modes of the device includes one or more of: a typing mode, a mouse mode, a scrolling mode.

32. The device of claim 15, wherein the touch sensor comprises one or more of:
a capacitive touch sensor;
a camera;
an acoustic touch sensor;
an optical touch sensor;
a temperature touch sensor;
a pressure based touch sensor;
a magnetic field based touch sensor and/or a Hall sensor;
a triboelectric touch sensor; and
a piezo-crystal.

33. A signal processor for an input device, the signal processor being arranged to:
receive a touch signal from a touch sensor, the touch signal corresponding to a movement of one or more objects on or above an upper surface of one or more input keys of the input device;
determine an active mode of the input device;
determine whether the touch signal is meaningful for the active mode;
determine a signalled mode of the input device based on the touch signal; and
enable the signalled mode and/or activate the signalled mode in dependence on the touch signal being meaningful for the signalled mode and not being meaningful for the active mode.

34. A method of operating an input device, comprising:
receiving a touch signal from a touch sensor, the touch signal corresponding to a movement of one or more objects on or above an upper surface of one or more input keys of the input device;
determining an active mode of the input device;
determining whether the touch signal is meaningful for the active mode;
determining a signalled mode of the input device based on the touch signal; and
enabling the signalled mode and/or activate the signalled mode in dependence on the touch signal being meaningful for the signalled mode and not being meaningful for the active mode.
